(19) United States
(12) Patent Application Publication
(10) Pub. No.: US 2026/0212446 A1
(43) Pub. Date: Jul. 23, 2026

(54) METHOD AND AN ELECTRONIC DEVICE FOR IMAGE DOWNSCALING

(71) Applicant: MediaTek Singapore Pte. Ltd., Singapore (SG)

(72) Inventors: QiuShi LIU, Beijing (CN); PengHui LIU, Beijing (CN); Qian DONG, Beijing (CN)

(21) Appl. No.: 19/032,855

(22) Filed: Jan. 21, 2025

(51) Int. Cl. G06T 3/40; G06T 1/20

(52) U.S. Cl. CPC G06T 3/40; G06T 1/20

(57) ABSTRACT

A method for image downscaling is provided. The method includes the following steps. An image with an original resolution is received. It is determined whether an automatic downscaling function is enabled. A power gain is calculated based on the difference between the original resolution and the target resolution in response to the automatic downscaling function being enabled. The image is downscaled from the original resolution to the target resolution in response to the power gain being higher than zero. The image with the target resolution is output.

### BACKGROUND OF THE INVENTION

### Field of the Invention

The present invention relates to image and video processing, and, in particular, it relates to a method and an electronic device for image downscaling.

### Description of the Related Art

Decoded video data often does not match the display area during video application (APP) playback (the video size is usually larger than the display area), requiring additional downscaling operations. Examples of such downscaling operations include vertical screen playback of horizontal screen content, horizontal screen playback of 4K content, small window playback, and picture-in-picture playback.

In order to perform these downscaling operations, the application starts an independent thread to call a graphics processor (GPU) to perform the downscaling operations on each frame of video content. However, the use of the GPU to perform a downscaling operation may cause the entire system to consume much more power. Finding a solution to replace the GPU for image downscaling becomes an important issue.

### BRIEF SUMMARY OF THE INVENTION

An embodiment of the present invention provides a method for image downscaling. The method includes the following steps. An image with an original resolution is received. It is determined whether an automatic downscaling function is enabled. A power gain is calculated based on the difference between the original resolution and the target resolution in response to the automatic downscaling function being enabled. The image is downscaled from the original resolution to the target resolution in response to the power gain being higher than zero. The image with the target resolution is output.

According to the method described above, the step of determining whether the automatic downscaling function is enabled includes the following steps. It is determined whether a downscaling function is forced off. It is determined whether the downscaling function is forced on. It is determined the automatic downscaling function is enabled in response to the downscaling function not being forced off and the downscaling function not being forced on.

The method further includes the following steps. The image with the original resolution is output in response to determining that the downscaling function is being forced off. The image with the target resolution is output in response to determining that the downscaling function is not being forced off and the downscaling function is being forced on.

The method further includes the following steps. The image with the original resolution is output in response to the power gain being less than or equal to zero.

According to the method described above, the step of calculating the power gain based on the difference between the original resolution and the target resolution in response to the automatic downscaling function being enabled includes the following step. The power gain is calculated using a first equation. The first equation is G=[(BW_{original-GPU-in}−BW_{target-GPU-in})+(BW_{original-GPU-out}−BW_{target-GPU-out})+(BW_{original-MM}−BW_{target-MM})]/C. BW_{original-GPU-in} is the bandwidth of the image with the original resolution input into a graphics processor; BW_{target-GPU-in} is the bandwidth of the image with the target resolution input into the graphics processor; BW_{original-GPU-out} is the bandwidth of the image with the original resolution output from the graphics processor; BW_{target-GPU-out} is the bandwidth of the image with the target resolution output from the graphics processor; BW_{original-MM} is the bandwidth of the image with the original resolution consumed by a processor to perform the downscaling function; BW_{target-MM} is the bandwidth of the image with the target resolution consumed by the processor to perform the downscaling function; and C is a bandwidth-to-power conversion unit.

The method further includes the following step. The bandwidth of the image with the original resolution input into the graphics processor, the bandwidth of the image with the target resolution input into the graphics processor, the bandwidth of the image with the original resolution output from the graphics processor, the bandwidth of the image with the target resolution output from the graphics processor, the bandwidth of the image with the original resolution consumed by the processor, and the bandwidth of the image with the target resolution consumed by the processor is calculated using a second equation. The second equation is BW=Res*PToB*Fps*BWCR. BW is the bandwidth, Res is the resolution of the image, PToB is the pixel memory usage conversion factor, Fps is the refresh rate, and BWCR is the bandwidth compression ratio.

According to the method described above, the bandwidth of the image with the original resolution consumed by the processor is equal to zero in response to the automatic downscaling function not being enabled.

According to the method described above, the bandwidth of the image with the target resolution consumed by the processor is higher than zero in response to the automatic downscaling function being enabled.

An embodiment of the present invention also provides an electronic device. The electronic device includes the processor. The processor receives an image with an original resolution, and executes a downscale module to determine whether an automatic downscaling function is enabled. The processor calculates a power gain based on the difference between the original resolution and the target resolution in response to the automatic downscaling function being enabled. The processor downscales the image from the original resolution to the target resolution in response to the power gain being higher than zero, and outputs the image with the target resolution.

According to the electronic device described above, the processor executes a configuration module to set a downscaling function to be forced off, or sets the downscaling function to be forced on, or sets the automatic downscaling function to be enabled.

According to the electronic device described above, the processor executes the configuration module to set the target resolution of the image.

The electronic device further includes a decoder. The decoder is electrically connected to the processor. The decoder sends the image with the original resolution to the processor.

According to the electronic device described above, the processor executes the downscale module to determine whether the downscaling function is forced off, determine whether the downscaling function is forced on, and determine the automatic downscaling function is enabled in response to the downscaling function not being forced off and the downscaling function not being forced on.

According to the electronic device described above, the processor executes the downscale module to output the image with the original resolution in response to determining that the downscaling function is being forced off, and output the image with the target resolution in response to determining that the downscaling function is not being forced off and the downscaling function is being forced on.

According to the electronic device described above, the processor executes the downscale module to output the image with the original resolution in response to the power gain being less than or equal to zero.

According to the electronic device described above, the processor executes the downscale module to calculate the power gain using a first equation. The first equation is

$$G = [ ( {BW}_{original - GPU - in} - {BW}_{target - GPU - in} ) + ( {BW}_{original - GPU - out} - {BW}_{target - GPU - out} ) + ( {BW}_{original - MM} - {BW}_{target - MM} ) ] / C . {BW}_{original - GPU - in}$$

is the bandwidth of the image with the original resolution input into a graphics processor; BW_{target-GPU-in} is the bandwidth of the image with the target resolution input into the graphics processor; BW_{original-GPU-out} is the bandwidth of the image with the original resolution output from the graphics processor; BW_{target-GPU-out} is the bandwidth of the image with the target resolution output from the graphics processor; BW_{original-MM} is the bandwidth of the image with the original resolution consumed by a processor to perform the downscaling function; BW_{target-MM} is the bandwidth of the image with the target resolution consumed by the processor to perform the downscaling function; and C is a bandwidth-to-power conversion unit.

According to the electronic device described above, the processor executes the downscale module to calculate the bandwidth of the image with the original resolution input into a graphics processor, the bandwidth of the image with the target resolution input into the graphics processor, the bandwidth of the image with the original resolution output from the graphics processor, the bandwidth of the image with the target resolution output from the graphics processor, the bandwidth of the image with the original resolution consumed by the processor, and the bandwidth of the image with the target resolution consumed by the processor using a second equation. The second equation is BW=Res*PToB*Fps*BWCR. BW is the bandwidth, Res is the resolution of the image, PToB is the pixel memory usage conversion factor, Fps is the refresh rate, and BWCR is the bandwidth compression ratio.

According to the electronic device described above, the bandwidth of the image with the original resolution consumed by the processor is equal to zero in response to the automatic downscaling function not being enabled.

According to the electronic device described above, the bandwidth of the image with the target resolution consumed by the processor is higher than zero in response to the automatic downscaling function being enabled.

According to the electronic device described above, the bandwidth is the amount of image data that are able to be transmitted per second.

### BRIEF DESCRIPTION OF THE DRAWINGS

The present invention can be more fully understood by reading the subsequent detailed description and examples with references made to the accompanying drawings, wherein:

FIG. 1 shows a flow chart of a method for image downscaling in accordance with some embodiments of the present invention;

FIG. 2 shows a detail flow chart of step S102 of the method for image downscaling in FIG. 1 in accordance with some embodiments of the present invention;

FIG. 3 shows a schematic diagram of an electronic device 350 accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

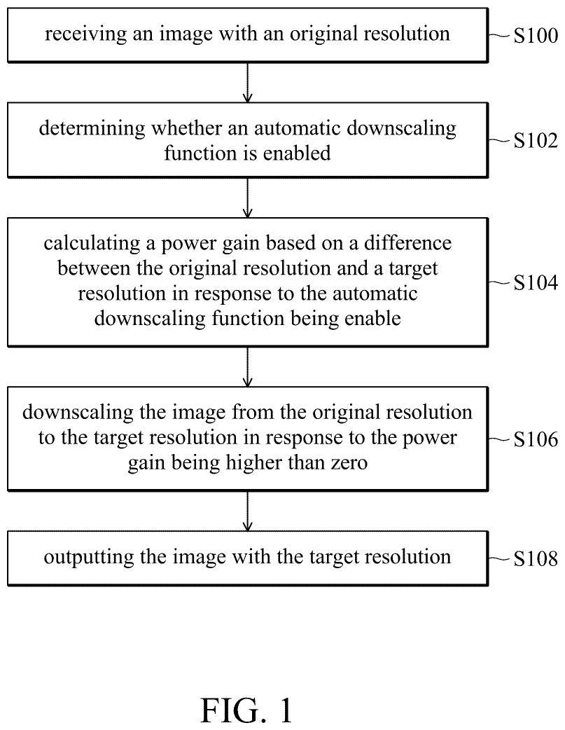

FIG. 1 shows a flow chart of a method for image downscaling in accordance with some embodiments of the present invention. As shown in FIG. 1, the method for image downscaling of the present invention includes the following steps. An image with an original resolution is received (step S100). It is determined whether an automatic downscaling function is enabled (step S102). A power gain is calculated based on the difference between the original resolution and the target resolution in response to the automatic downscaling function being enabled (step S104). The image is downscaled from the original resolution to the target resolution in response to the power gain being higher than zero (step S106). The image with the target resolution is output (step S108). In some embodiments, the steps S100~S108 are performed by a processor in an electronic device. The processor is electrically connected to a graphics processor (GPU).

In step S100, the image with the original resolution is from a decoder in the electronic device. In step S102, a configure module executed by the processor determines that a downscaling function is forced on. Alternatively, the configure module determines that the downscaling function is forced off. Alternatively, the configure module determines the automatic downscaling function is enabled. In step S104, a downscale module executed by the processor calculates the power gain using an equation 1. The equation 1 is shown in the next paragraph.

$$G = [ ( {BW}_{original - GPU - in} - {BW}_{target - GPU - in} ) + ( {BW}_{original - GPU - out} - {BW}_{target - GPU - out} ) + ( {BW}_{original - MM} - {BW}_{target - MM} ) ] / C . \qquad equation 1$$

BW_{original-GPU-in} is the bandwidth of the image with the original resolution input into a graphics processor. BW_{target-GPU-in} is the bandwidth of the image with the target resolution input into the graphics processor. BW_{original-GPU-out} is the bandwidth of the image with the original resolution output from the graphics processor. BW_{target-GPU-out} is the bandwidth of the image with the target resolution output from the graphics processor. BW_{original-MM} is the bandwidth of the image with the original resolution consumed by a processor to perform the downscaling function. BW_{target-MM} is the bandwidth of the image with the target resolution consumed by the processor to perform the downscaling function. C is a bandwidth-to-power conversion unit.

Furthermore, the downscale module executed by the processor calculates the bandwidth BW_{original-GPU-in} of the image with the original resolution input into the graphics processor, the bandwidth BW_{target-GPU-in} of the image with the target resolution input into the graphics processor, the bandwidth BW_{original-GPU-out} of the image with the original resolution output from the graphics processor, the bandwidth BW_{target-GPU-out}of the image with the target resolution output from the graphics processor, the bandwidth BW_{original-MM} of the image with the original resolution consumed by the processor, and the bandwidth BW_{target-MM} of the image with the target resolution consumed by the processor using an equation 2. The equation 2 is shown in the next paragraph.

$$BW = Res * PToB * Fps * BWCR . \qquad equation 2$$

BW is the bandwidth, Res is the resolution of the image, PToB is the pixel memory usage conversion factor, Fps is the refresh rate, and BWCR is the bandwidth compression ratio. For example, when the downscale module calculates the bandwidth BW_{original-GPU-in} of the image with the original resolution input into the graphics processor, it substitutes the bandwidth BW by the bandwidth BW_{original-GPU-in}in equation 2. When the downscale module calculates the bandwidth BW_{target-GPU-out}, it substitutes the bandwidth BW by the bandwidth BW_{original-GPU-in} in equation 2. In some embodiments, the bandwidth BW is the amount of image data that are able to be transmitted per second. In some embodiments, a parameter that is equal to the resolution of the image Res multiplied by the pixel memory usage conversion factor PToB is an occupied memory space per image (Res*PToB). A parameter that is equal to the resolution of the image Res multiplied by the pixel memory usage conversion factor PToB and the refresh rate Fps is a bandwidth occupied by the transmission before compression (Res*PToB* Fps). The bandwidth BW is a bandwidth occupied by the transmission after compression.

In some embodiments, the bandwidth BW_{original-MM} of the image with the original resolution consumed by the processor is equal to zero in response to the automatic downscaling function not being enabled. In some embodiments, the bandwidth BW_{target-MM} of the image with the target resolution consumed by the processor is higher than zero in response to the automatic downscaling function being enabled.

Next, in step S106, the downscale module executed by the processor downscales the image from the original resolution to the target resolution in response to the power gain being higher than zero, and outputs the image with the target resolution in step S108. Alternatively, the downscale module executed by the processor outputs the image with the original resolution in response to the power gain being less than or equal to zero.

In some embodiments, the downscale module executed by the processor outputs the image with the original resolution in response to determining that the downscaling function is being forced off. In some embodiments, the downscale module executed by the processor outputs the image with the target resolution in response to determining that the downscaling function is not being forced off and the downscaling function is being forced on.

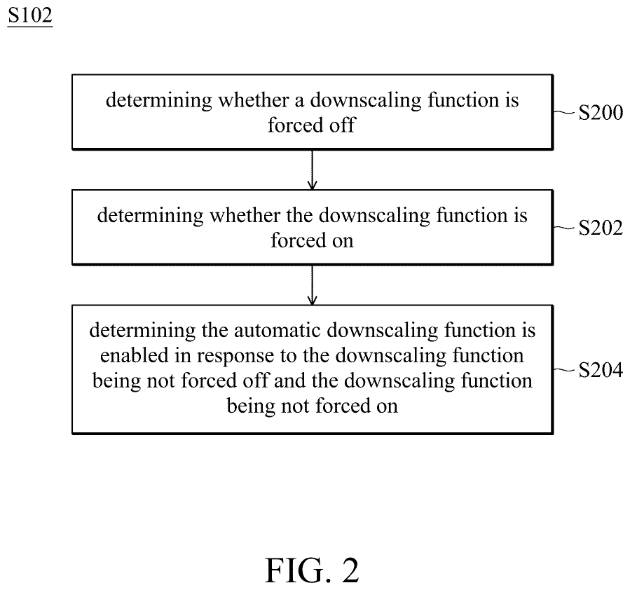

FIG. 2 shows a detail flow chart of step S102 of the method for image downscaling in FIG. 1 in accordance with some embodiments of the present invention. As shown in FIG. 2, the method for image downscaling of the present invention includes the following steps. The downscale module executed by the processor determines whether the downscaling function is forced off (step S200). The downscale module executed by the processor determines whether the downscaling function is forced on (step S202). The downscale module executed by the processor determines the automatic downscaling function is enabled in response to the downscaling function not being forced off and the downscaling function not being forced on (step S204).

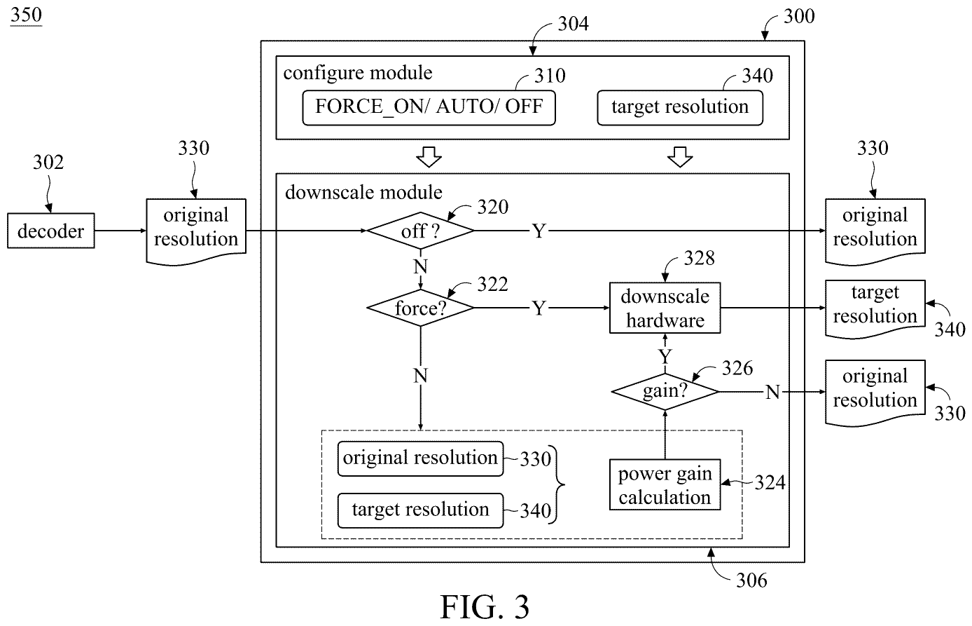

FIG. 3 shows a schematic diagram of an electronic device 350 accordance with some embodiments of the present invention. As shown in FIG. 3, the electronic device 350 includes a processor 300 and a decoder. The processor 300 receives an image with an original resolution 330 from the decoder 302. The processor 300 executes a downscale module 306 to determine whether an automatic downscaling function is enabled, and calculates a power gain based on the difference between the original resolution 330 and the target resolution 340 in response to the automatic downscaling function being enabled. The processor 300 downscales the image from the original resolution 330 to the target resolution 340 in response to the power gain being higher than zero, and outputs the image with the target resolution 340.

The decoder 302 is electrically connected to the processor 300. The decoder 302 sends the image with the original resolution 330 to the processor 300. The processor 300 executes a configuration module 304 to set a downscaling function to be forced off (OFF), or set the downscaling function to be forced on (FORCE_ON), or set the automatic downscaling function to be enabled (AUTO) in function block 310. In some embodiments, the processor 300 further executes the configuration module 304 to set the target resolution 340 of the image.

In detail, the processor 300 executes the downscale module 306 to determine whether the downscaling function is forced off in step 320. If the answer is yes in step 320, the processor 300 executes the downscale module 306 to output the image with the original resolution 330 in response to determining that the downscaling function is being forced off. If the answer is no in step 320, the processor 300 executes the downscale module 306 to determine whether the downscaling function is forced on in step 322. In some embodiments, the processor 300 includes downscale hardware 328 dedicated to downscaling. If the answer is yes in step 322, the processor 300 enables the downscale hardware 328 to downscale the image from the original resolution 330 to the target resolution 340, so that the processor 300 outputs the image with the target resolution 340.

If the answer is no in step 322, the processor 300 determines the automatic downscaling function is enabled in response to the downscaling function not being forced off and the downscaling function not being forced on. If the answer is no in step 322, the processor 300 executes the downscale module 306 to compare the image with original resolution 330 and the image with target resolution 340. After that, the processor 300 executes the downscale module 306 to calculate a power gain (for example, block 324) based on the difference between the original resolution 330 and the target resolution. Next, the processor 300 executes the downscale module 306 to determine whether the power gain is higher than zero or not in step 326. In some embodiments, if the power gain is higher than zero (that is, the answer is yes in step 326), the processor 300 enables the downscale hardware 328 to downscale the image from the original resolution 330 to the target resolution 340, so that the processor 300 outputs the image with the target resolution 340. if the power gain is less than or equal to zero (that is, the answer is no in step 326), the processor 300 outputs the image with the original resolution 330 in response to the power gain being less than or equal to zero.

In detail, the electronic device 350 further includes a graphic processor (not shown) to downscale the image in the prior art. The downscale operations of the graphic processor are replaced by the downscale operations of the downscale hardware 328 in the processor 300. The processor 300 executes the downscale module 306 to calculate the power gain using the equation 1. The processor 300 executes the downscale module 306 to calculate the bandwidth BW_{original-GPU-in} of the image with the original resolution 330 input into the graphics processor, and the bandwidth BW_{target-GPU-in} of the image with the target resolution 340 input into the graphics processor using the equation 2. The processor 300 executes the downscale module 306 to calculate the bandwidth BW_{original-GPU-out} of the image with the original resolution 330 output from the graphics processor, and the bandwidth BW_{target-GPU-out} of the image with the target resolution 340 output from the graphics processor using the equation 2. Similarly, the processor 300 executes the downscale module 306 to calculate the bandwidth BW_{original-MM} of the image with the original resolution 330 consumed by the processor 300 to perform the downscaling function (for example, the downscale hardware 328), and the bandwidth BW_{target-MM} of the image with the target resolution 340 consumed by the processor to perform the downscaling function (for example, the downscale hardware 328) using the equation 2.

In some embodiments, the bandwidth BW_{original-MM} of the image with the original resolution 330 consumed by the processor 300 is equal to zero in response to the automatic downscaling function not being enabled. In some embodiments, the bandwidth BW_{target-MM} of the image with the target resolution 340 consumed by the processor 300 is higher than zero in response to the automatic downscaling function being enabled.

The method and the electronic device 350 for image downscaling of the present invention reduces multiple frequency indicators of the GPU. For example, GPU Urate, GPU ITER Urate, TA Urate, and 3D Urate all declined. GPU Urate represents the activity level of the GPU core, that is, the proportion of the GPU core occupied within a period of time. GPU ITER Urate indicates the activity of the graphics processing unit iterator. GPU TA Urate represents the activity of the unit in the GPU responsible for processing texture mapping and filtering. GPU 3D Urate indicates the activity level of the unit responsible for 3D graphics rendering in the GPU (such as geometry processor, rasterization unit, etc.).

The method and the electronic device 350 for image downscaling of the present invention reduces the usage of both external memory interface (EMI) bandwidth and dynamic random-access memory (DRAM) bandwidth. EMI BW is similar in concept to DRAM BW. The statistical process is basically the same. The statistical content is the bandwidth usage during data transmission between memory, GPU and CPU.

The method and the electronic device 350 for image downscaling of the present invention reduce current consumption by 7 mA when the images having 4K resolutionare received by the processor 300 and the electronic device 350 has 1080 pixels of display resolution.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for image downscaling, comprising:
receiving an image with an original resolution;
determining whether an automatic downscaling function is enabled;
calculating a power gain based on a difference between the original resolution and a target resolution in response to the automatic downscaling function being enabled;
downscaling the image from the original resolution to the target resolution in response to the power gain being higher than zero; and
outputting the image with the target resolution.

2. The method as claimed in claim 1, wherein the step of determining whether the automatic downscaling function is enabled comprises:
determining whether a downscaling function is forced off;
determining whether the downscaling function is forced on; and
determining the automatic downscaling function is enabled in response to the downscaling function not being forced off and the downscaling function not being forced on.

3. The method as claimed in claim 2, further comprising:
outputting the image with the original resolution in response to determining that the downscaling function is being forced off; and
outputting the image with the target resolution in response to determining that the downscaling function is not being forced off and the downscaling function is being forced on.

4. The method as claimed in claim 1, further comprising:
outputting the image with the original resolution in response to the power gain being less than or equal to zero.

5. The method as claimed in claim 1, wherein the step of calculating the power gain based on the difference between the original resolution and the target resolution in response to the automatic downscaling function being enabled comprises:
calculating the power gain using a first equation; wherein the first equation is:
$$G = [ ( {BW}_{original - GPU - in} - {BW}_{target - GPU - in} ) + ( {BW}_{original - GPU - out} - {BW}_{target - GPU - out} ) + ( {BW}_{original - MM} - {BW}_{target - MM} ) ] / C ;$$
wherein BW_{original-GPU-in} is a bandwidth of the image with the original resolution input into a graphics processor; BW_{target-GPU-in} is a bandwidth of the image with the target resolution input into the graphics processor; BW_{original-GPU-out} is a bandwidth of the image with the original resolution output from the graphics processor; BW_{target-GPU-out} is a bandwidth of the image with the target resolution output from the graphics processor; BW_{original-MM} is a bandwidth of the image with the original resolution consumed by a processor to perform the downscaling function; BW_{target-MM} is a bandwidth of the image with the target resolution consumed by the processor to perform the downscaling function; and C is a bandwidth-to-power conversion unit.

6. The method as claimed in claim 5, further comprising:
calculating the bandwidth of the image with the original resolution input into the graphics processor, the bandwidth of the image with the target resolution input into the graphics processor, the bandwidth of the image with the original resolution output from the graphics processor, the bandwidth of the image with the target resolution output from the graphics processor, the bandwidth of the image with the original resolution consumed by the processor, and the bandwidth of the image with the target resolution consumed by the processor using a second equation; wherein the second equation is:
$$BW = Res * PToB * Fps * BWCR ;$$
wherein BW is the bandwidth, Res is a resolution of the image, PToB is a pixel memory usage conversion factor, Fps is a refresh rate, and BWCR is a bandwidth compression ratio.

7. The method as claimed in claim 6, wherein the bandwidth of the image with the original resolution consumed by the processor is equal to zero in response to the automatic downscaling function not being enabled.

8. The method as claimed in claim 6, wherein the bandwidth of the image with the target resolution consumed by the processor is higher than zero in response to the automatic downscaling function being enabled.

9. An electronic device, comprising:
a processor, configured to receive an image with an original resolution, execute a downscale module to determine whether an automatic downscaling function is enabled, calculate a power gain based on the difference between the original resolution and the target resolution in response to the automatic downscaling function being enabled, downscale the image from the original resolution to the target resolution in response to the power gain being higher than zero, and output the image with the target resolution.

10. The electronic device as shown in claim 9, wherein the processor executes a configuration module to set a downscaling function to be forced off, or set the downscaling function to be forced on, or set the automatic downscaling function to be enabled.

11. The electronic device as shown in claim 10, wherein the processor executes the configuration module to set the target resolution of the image.

12. The electronic device as shown in claim 9, further comprising:
a decoder, electrically connected to the processor, configured to send the image with the original resolution to the processor.

13. The electronic device as shown in claim 9, wherein the processor executes the downscale module to determine whether a downscaling function is forced off, determine whether the downscaling function is forced on, and determine the automatic downscaling function is enabled in response to the downscaling function not being forced off and the downscaling function not being forced on.

14. The electronic device as shown in claim 13, wherein the processor executes the downscale module to output the image with the original resolution in response to determining that the downscaling function is being forced off, and output the image with the target resolution in response to determining that the downscaling function is not being forced off and the downscaling function is being forced on.

15. The electronic device as shown in claim 9, wherein the processor executes the downscale module to output the image with the original resolution in response to the power gain being less than or equal to zero.

16. The electronic device as shown in claim 9, wherein the processor executes the downscale module to calculate the power gain using a first equation; wherein the first equation is:
$$G = [ ( {BW}_{original - GPU - in} - {BW}_{target - GPU - in} ) + ( {BW}_{original - GPU - out} - {BW}_{target - GPU - out} ) + ( {BW}_{original - MM} - {BW}_{target - MM} ) ] / C ;$$
wherein BW_{original-GPU-in} is a bandwidth of the image with the original resolution input into a graphics processor; BW_{target-GPU-in} is a bandwidth of the image with the target resolution input into the graphics processor; BW_{original-GPU-out} is a bandwidth of the image with the original resolution output from the graphics processor; BW_{target-GPU-out} is a bandwidth of the image with the target resolution output from the graphics processor; BW_{original-MM} is a bandwidth of the image with the original resolution consumed by a processor to perform the downscaling function; BW_{target-MM} IS a bandwidth of the image with the target resolution consumed by the processor to perform the downscaling function; and C is a bandwidth-to-power conversion unit.

17. The electronic device as shown in claim 16, wherein the processor executes the downscale module to calculate the bandwidth of the image with the original resolution input into a graphics processor, the bandwidth of the image with the target resolution input into the graphics processor, the bandwidth of the image with the original resolution output from the graphics processor, the bandwidth of the image with the target resolution output from the graphics processor, the bandwidth of the image with the original resolution consumed by the processor, and the bandwidth of the image with the target resolution consumed by the processor using a second equation; wherein the second equation is:
$$BW = Res * PToB * Fps * BWCR ;$$
wherein BW is the bandwidth, Res is the resolution of the image, PToB is a pixel memory usage conversion factor, Fps is a refresh rate, and BWCR is a bandwidth compression ratio.

18. The electronic device as shown in claim 9, wherein the bandwidth of the image with the original resolution consumed by the processor is equal to zero in response to the automatic downscaling function not being enabled.

19. The electronic device as shown in claim 9, wherein the bandwidth of the image with the target resolution consumed by the processor is higher than zero in response to the automatic downscaling function being enabled.

20. The electronic device as shown in claim 17, wherein the bandwidth is the amount of image data that are able to be transmitted per second.
